(19) United States
(12) Patent Application Publication
(10) Pub. No.: US 2024/0046572 A1
(43) Pub. Date: Feb. 8, 2024

(54) SYSTEMS, DEVICES, AND METHODS FOR GENERATING A POLYGON MESH MODEL

(71) Applicant: Sanctuary Cognitive Systems Corporation, Vancouver (CA)

(72) Inventors: Jonathan McCully Moore, Nanaimo (CA); Mani Ranjbar, Port Coquitlam (CA)

(21) Appl. No.: 18/231,643

(22) Filed: Aug. 8, 2023

Related U.S. Application Data
(60) Provisional application No. 63/396,058, filed on Aug. 8, 2022.

(51) Int. Cl. G06T 17/20

(52) U.S. Cl. CPC G06T 17/205; G06T 2210/21

(57) ABSTRACT

An example computer-implemented method for reducing a number of polygons in a polygon mesh model of an object determines one or more viewpoints, and, for each viewpoint of the one or more viewpoints, determines a respective first subset of polygons of the set of one or more polygons, the respective first subset of polygons being candidates for removal from the polygon mesh model. The method further determines a first intersection of the respective first subsets of polygons, and removes from the polygon mesh model at least some of the polygons in the first intersection. The method identifies candidates for removal from the polygon mesh model as those polygons of the set of one or more polygons which are non-visible in the computer simulation from the one or more viewpoints.

### TECHNICAL FIELD

The present systems, devices, and methods generally relate to the generation of polygon mesh models, and, in particular, relate to reducing a size of a polygon mesh model. The present systems, devices, and methods can be applied to the modeling and simulation of robots, robotic systems and their environments, for example.

### BACKGROUND

A polygon mesh model comprises a collection of vertices, edges, and faces that define a shape of a polyhedral object. The faces are usually polygons. The faces may include convex and/or concave polygons. In some examples, the faces include triangles. In other examples, the faces include quadrilaterals. In some examples, the polygon mesh model comprises polygons consisting of a coplanar set of faces. Polygon mesh models are typically used in 3D computer graphics and geometric modeling.

Robots are machines that can assist humans or substitute for humans. Robots can be used in diverse applications including construction, manufacturing, monitoring, exploration, learning, and entertainment. Robots can be used in dangerous or uninhabitable environments, for example.

Robots, robot systems, and their environments can be modeled using polygon mesh models. Modeled objects can include internal and external components. Internal components may not be visible from some viewpoints.

Modeled objects may be articulated. An articulated object is an object composed of two or more rigid parts connected by one or more joints that allow rotational and/or translational motion in one, two, and/or three dimensions. Some components of the articulated object may not be visible from some viewpoints at some articulations.

Components of objects and articulated objects can be converted to polygons, for example, when meshed for rendering in a computer simulation.

A modeled object may be a simulated representation of a physical object.

### BRIEF SUMMARY

A computer-implemented method for reducing a number of polygons in a polygon mesh model of an object, the polygon mesh model of the object comprising a set of one or more polygons, wherein the reducing a number of polygons in a polygon mesh model of an object may be summarized as including determining one or more viewpoints, for each viewpoint of the one or more viewpoints, determining a respective first subset of polygons of the set of one or more polygons, the respective first subset of polygons being candidates for removal from the polygon mesh model, determining a first intersection of the respective first subsets of polygons, and removing from the polygon mesh model at least some of the polygons in the first intersection.

In some implementations, the object comprises a plurality of parts, and the reducing a number of polygons in a polygon mesh model of an object includes removing at least a portion of a first part. The polygon mesh model may include a first polygon mesh of the first part, the at least of a portion of the first part consists of a second subset of the set of one or more polygons, and the removing at least a portion of the first part may include removing the second subset from the polygon mesh model.

In some implementations, the object comprises a plurality of parts, the polygon mesh model comprises a first polygon mesh for a first part of the plurality of parts, and the reducing a number of polygons in a polygon mesh model of an object includes decimating the first polygon mesh.

In some implementations, the object is a CAD model. The CAD model may include an internal surface, the internal surface non-visible for each viewpoint of the one or more viewpoints, wherein the removing from the polygon mesh model at least some of the polygons in the first intersection may include removing at least some of the polygons of the internal surface.

In some implementations, the object is a simulated representation of a physical object.

In some implementations, the object includes a robot.

In some implementations, the object includes an environment of a robot.

In some implementations, the set of one or more polygons is a set of one or more triangles.

In some implementations, the determining one or more viewpoints includes determining one or more randomly-located points on a bounding sphere of the object.

In some implementations, for each viewpoint of the one or more viewpoints, the determining a respective first subset of polygons of the set of one or more polygons, the respective first subset of polygons being candidates for removal from the polygon mesh model, includes identifying polygons of the set of one or more polygons which are non-visible from each viewpoint. The identifying polygons of the set of one or more polygons which are non-visible from each viewpoint may include determining which polygons of the set of one or more polygons are untouched by rays drawn to the object from each viewpoint. The determining which polygons of the set of one or more polygons are untouched by rays drawn to the object from each viewpoint may include determining which polygons of the set of one or more polygons are untouched by straight-line rays drawn to the object from each viewpoint.

In operation, the polygon mesh model of the object may be used in a computer simulation, and, for each viewpoint of the one or more viewpoints, the determining a respective first subset of polygons of the set of one or more polygons, the respective first subset of polygons being candidates for removal from the polygon mesh model, may include identifying polygons of the set of one or more polygons which are non-visible in the computer simulation from each viewpoint.

In some implementations, for each viewpoint of the one or more viewpoints, the determining a respective first subset of polygons of the set of one or more polygons, the respective first subset of polygons being candidates for removal from the polygon mesh model, includes identifying a respective second subset of polygons of the set of one or more polygons, the respective second subset of polygons which are visible from the viewpoint, and determining the respective first subset of polygons of the set of one or more polygons from at least some of the polygons in a complement of the respective second subset of polygons.

In some implementations, the method further comprises determining one or more articulations of the object, wherein the determining a respective first subset of polygons of the set of one or more polygons, the respective first subset of polygons being candidates for removal from the polygon mesh model, includes for each articulation, determining a respective second subset of polygons of the set of one or more polygons, the respective second subset of polygons which are non-visible from each viewpoint, determining a second intersection of the respective second subsets of polygons, and determining the respective first subset of polygons from at least some of the polygons in the second intersection.

A computer system may be summarized as comprising a controller, the controller comprising at least one processor, and at least one non-transitory processor-readable storage medium communicatively coupled to the at least one processor, the at least one non-transitory processor-readable storage medium storing processor-executable instructions and/or data that, when executed by the at least one processor, cause the computer system to perform a method for reducing a number of polygons in a polygon mesh model of an object, the polygon mesh model of the object comprising a set of one or more polygons, the method according to any of the implementations described above.

A computer program product may be summarized as comprising data and processor-executable instructions stored in a non-volatile processor-readable storage medium that, when executed by a processor communicatively coupled to the storage medium, causes the processor to perform a method for reducing a number of polygons in a polygon mesh model of an object, the polygon mesh model of the object comprising a set of one or more polygons, the method according to any of the implementations described above.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1A is a schematic drawing of an example implementation of a polygon mesh model of a simple geometric object before selective decimation, in accordance with the present systems, devices, and methods.

FIG. 1B is a schematic drawing of a polygon mesh model generated by selectively decimating the polygon mesh model of FIG. 1A, in accordance with the present systems, devices, and methods.

FIG. 1C is another schematic drawing of the polygon mesh model of FIG. 1A, in accordance with the present systems, devices, and methods.

FIG. 2A is a schematic drawing of a side view of an example implementation of a polygon mesh model of a CAD model of a robot's head before selective decimation, in accordance with the present systems, devices, and methods.

FIG. 2B is a schematic drawing of a side view of a polygon mesh model generated by selectively decimating the polygon mesh model of FIG. 2A, in accordance with the present systems, devices, and methods.

FIG. 3A is a schematic drawing of an isometric view of an example implementation of a polygon mesh model of a CAD model of a robot's head before selective decimation, in accordance with the present systems, devices, and methods.

FIG. 3B is a schematic drawing of a side view of a polygon mesh model generated by selectively decimating the polygon mesh model of FIG. 3A, in accordance with the present systems, devices, and methods.

FIG. 4 is a schematic drawing of an example implementation of a hydraulically-powered robot, in accordance with the present systems, devices, and methods.

FIG. 5A is a flow chart of an example implementation of a computer-implemented method for reducing a number of polygons in a polygon mesh model of an object, in accordance with the present systems, devices, and methods.

FIGS. 5B and 5C are flow charts of example implementations of further detail of the method of FIG. 5A, in accordance with the present systems, devices, and methods.

FIG. 6 is a block diagram of an example implementation of a computer, in accordance with the present systems, devices, and methods.

### DETAILED DESCRIPTION

The following description sets forth specific details in order to illustrate and provide an understanding of various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

In computer graphics, 3D engines often use triangles to draw surfaces. While drawing surfaces using triangles can be memory-efficient, there is a memory cost associated with the storage of each triangle that belongs to the surface. In general, more/smaller triangles can correspond to more detail and improved quality of the graphics (e.g., improved textures, higher resolution, etc.), whereas fewer/larger triangles can correspond to coarser detail that can facilitate faster rendering and processing.

Reducing the number of polygons in a polygon mesh model, while attempting to preserve a good approximation of an original topology and maintain a good approximation of an original geometry, is referred to in the present application as decimation. In some implementations, decimation is based on a surface geometry. For example, decimation can include identifying a set of abutting and coplanar triangles, and replacing them with a smaller number of larger triangles. In some implementations, decimation includes replacing coplanar triangles by higher order polygons. Replacing coplanar triangles by a smaller number of larger polygons can include refilling the same area with the smaller number of larger polygons.

Conventional decimation techniques typically degrade visual quality of a polygon mesh model. In some situations, after decimation, visual integrity can be restored by manually editing the polygon mesh model. Restoration is typically only practical for a single mesh object or a compound object having only a small number of mesh components.

The technology described herein includes systems and methods for selectively decimating a polygon mesh model while preserving visual quality. One aspect of the technology includes selectively decimating the polygon mesh model by removing polygons that are non-visible from viewpoints of interest (e.g., polygons that cannot be seen from viewpoints of interest).

Robots are multi-body objects with articulated components. In one implementation of a polygon mesh model of a CAD model of a robot, the polygon mesh model includes more than ten million triangles. The technology described herein is especially well-suited to multi-body objects and/or articulated objects.

Multi-body objects and articulated objects can be composed of multiple polygon mesh models, and can be selectively decimated as described herein in a way that does not rely on surface geometry alone. The technology described herein removes non-visible polygons from the polygon mesh model. This approach differs from a conventional, and often uniform, decimation of the entire polygon mesh model.

One approach in the technology described herein is to trace rays from a representative number of viewpoints, and remove only those polygons the rays don't intersect, e.g., only those polygons not visible from any of the viewpoints. Similarly, an articulated object can be configured in a representative number of articulations, and polygons removed if the rays don't intersect the polygons for any of the articulations. Rays may be straight-line rays. Polygons the rays don't intersect are also referred to in the present application as polygons untouched by rays drawn to the object from the viewpoint.

A benefit of the technology described herein is that the size of the polygon mesh model can be reduced with less degradation in visual quality than conventional methods.

Robotics often uses computer models and simulations of robots, robotic systems, and/or their environment. In some implementations, the computer models and simulations are part of the robot's control architecture. In these implementations, the robot can build a computer simulation of itself and/or its environment (sometimes in real-time or near real-time), and can inhabit the simulation, e.g., determine its actions in real-life using the simulation. It can be desirable to be able to build a computer simulation of robots, robotic systems, and their environment with a higher degree of fidelity than conventional methods typically allow, while incurring a lower cost in computation and memory.

In some implementations, a polygon mesh model of a robot, robotic system, and/or its environment derives from a CAD (Computer-Aided Design) model. A CAD model typically uses a mathematical representation of a complex 3D geometry, and one approach is to use Non-uniform Rational B-Splines (NURBS). Converting surfaces in the CAD model to polygons in a polygon mesh model (which can be desirable for rendering and physics simulation) can result in large polygon mesh models (e.g., polygon mesh models that include several million polygons).

In addition, given the complexity of robots, robot systems, and their environments, the CAD model can be detailed and can include many parts, even nuts and bolts. A polygon mesh model of a complete robot CAD model may include polygon surfaces on all component parts of the robot CAD model, including such nuts and bolts. This can lead to the polygon mesh model of the robot CAD model having a large number of polygons, and polygon mesh models with large numbers of polygons can lead to poor performance and/or poor scalability of a simulation.

It can be desirable to reduce the number of polygons used to represent the complete system (e.g., the complete robot or complete robot CAD model) without appreciably reducing visual quality. It can also be desirable to remove from the polygon mesh model internal parts and/or other parts that are included in the system model (e.g., included in the robot CAD model) but not viewable and/or are not engaged in the simulation.

Conventional decimation techniques can be used to reduce polygon count, e.g., by merging multiple polygons. Conventional decimation techniques typically perform a uniform reduction of polygon count across the polygon mesh model, rather than focusing on reduction of polygons in areas of relatively high density. As a result, areas of relatively high density tend to be under-decimated, while areas of relatively low density tend to be over-decimated. Under-decimation can be insufficient to achieve a desired memory/computation reduction, whereas over-decimation can lead to poor visual quality of decimated polygon mesh models. Conventional decimation techniques give no consideration to which surfaces are actually viewable after being placed as part of an assembly in the object. Some surfaces may be internal surfaces, for example.

Another approach is to decimation is to manually remodel each part by hand, which can be time-intensive.

Yet another approach is to review each part of the CAD model (e.g., by a manual review), and add a tag to each part to indicate whether or not to export it from the CAD model. This approach may be impractical because there are usually many parts to review, and the parts are typically evolving during design. Moreover, it can be difficult to assess by review during design which parts will be externally observable in the object as-built, especially if the object being modeled is capable of motion/locomotion (such as a robot).

Existing decimation techniques in computer graphics give no regard to the visibility of surfaces being decimated. This is probably reasonable for models that have been made for graphics purposes (like video game objects), since there will have been no need to model internal and/or non-visible components. However, for complicated models exported out of CAD (like robot models), there may be a large number of internal components and corresponding internal surfaces that are converted to polygons when meshed for rendering in simulation. The technology described herein can significantly reduce the number of polygons in the polygon mesh model by making visibility a determining factor in decimation.

One approach to determining non-visible polygons is to identify visible polygons, and deduce from these which polygons are not visible, e.g., by taking the complement of the set of visible polygons. Non-visible polygons can be removed from the polygon mesh model without degrading visual fidelity of the model in a simulated environment.

The set of elements that are common to two given sets is referred to in the present application as an intersection of the two given sets. The difference between a given set and a universal set is referred to in the present application as a complement of the given set.

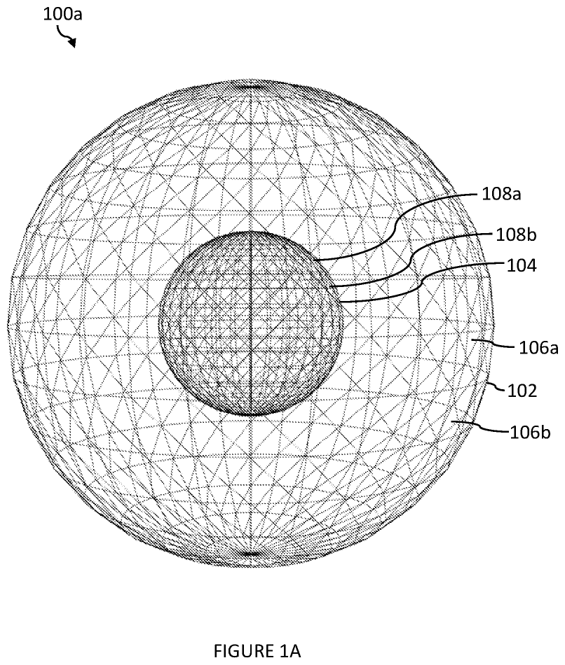

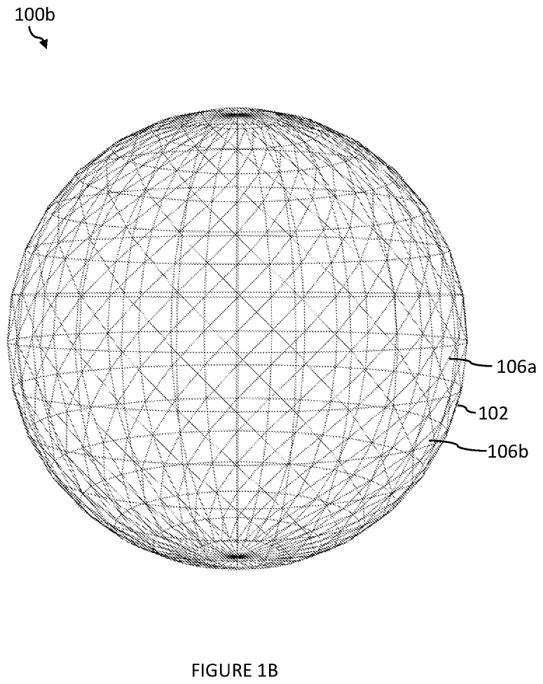

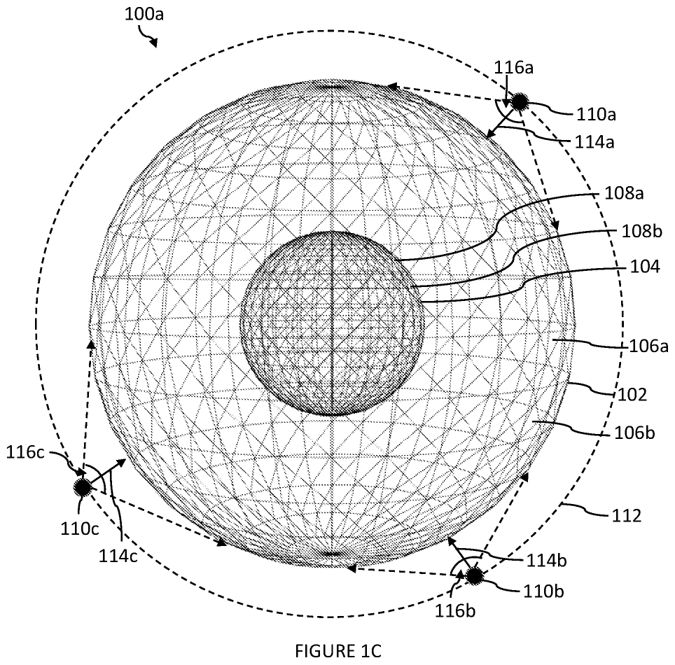

FIG. 1A is a schematic drawing of an example implementation of a polygon mesh model 100a of a simple geometric object before selective decimation, in accordance with the present systems, devices, and methods. The geometric object consists of a hollow sphere 102 enclosing another smaller, concentric sphere 104.

Sphere 102 is represented in polygon mesh model 100a by a plurality of triangles collectively referred to as triangles 106. For clarity, only two example triangles 106a and 106b of triangles 106 are labeled in FIG. 1A. Similarly, sphere 104 is represented in polygon mesh model 100a by a plurality of triangles collectively referred to as triangles 108. For clarity, only two example triangles 108a and 108b of triangles 108 are labeled in FIG. 1A.

In polygon mesh model 100a, sphere 104 is inside sphere 102. Since viewpoints of interest in the example implementations illustrated in FIGS. 1A and 1B lie outside sphere 102, and the exterior surface of sphere 102 is opaque, it can be determined that no polygons belonging to sphere 104 (i.e., none of triangles 108) are visible from the viewpoints. Polygon mesh model 100a can be decimated by removing triangles 108.

In this example, sphere 104 can be removed in its entirety from polygon mesh model 100a. In other examples, only a portion of triangles 108 are removed from polygon mesh model 100a. FIG. 1B is a schematic drawing of a polygon mesh model 100b generated by selectively decimating polygon mesh model 100a of FIG. 1A, in accordance with the present systems, devices, and methods. Polygon mesh model 100b includes sphere 102, and triangles 106 (only triangles 106a and 106b shown in FIG. 1B).

FIG. 10 is another schematic drawing of polygon mesh model 100a of FIG. 1A, in accordance with the present systems, devices, and methods. FIG. 10 includes representative viewpoints 110a, 110b, and 110c (collectively referred to as viewpoints 110). In some implementations, representative viewpoints are one or more randomly-located points on one or more bounding spheres of the object. Viewpoints 110 are located on a bounding sphere 112.

Rays 114a, 114b, and 114c (collectively referred to as rays 114) are constructed from viewpoints 110a, 110b, and 110c, respectively. In some implementations, a respective cone of rays 116a, 116b, and 116c is constructed from each of viewpoints 110a, 110b, and 110c. Cones 116a, 116b, and 116c include rays 114a, 114b, and 114c, respectively. Since sphere 102 is opaque, rays 114 do not intersect with triangles 108 of sphere 104. As a result, it can be determined that sphere 104 is not visible, and triangles 108 can be removed from polygon mesh model 100a of FIG. 1A to generate decimated polygon mesh model 100b of FIG. 1B.

Viewpoints and rays can be selected to provide a desired degree of coverage of an outside surface of sphere 102. The desired degree of coverage may include complete or partial coverage of the outside surface of sphere 102. Viewpoints and rays may be selected using a sampling scheme. Viewpoints and rays may be selected to provide the desired degree of coverage more efficiently, e.g., with less overlap between rays.

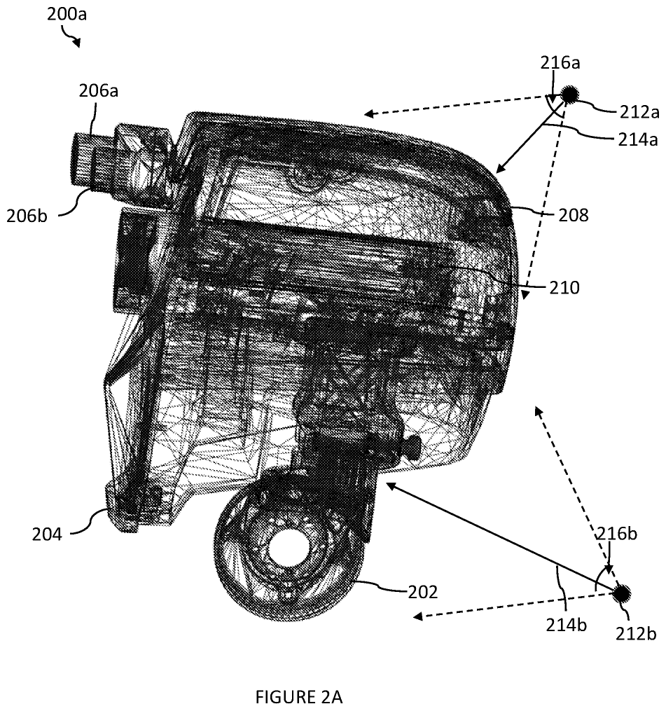

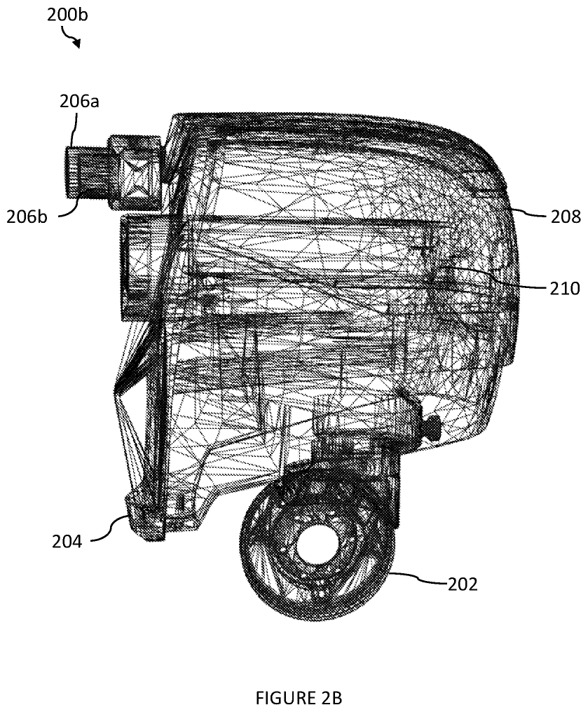

FIG. 2A is a schematic drawing of a side view of an example implementation of a polygon mesh model 200a of a CAD model of a robot's head before selective decimation, in accordance with the present systems, devices, and methods. The robot's head includes a number of parts including a neck 202, a jaw 204, eyes 206a and 206b, a skull 208, and internal components 210. Internal components 210 may include a controller, for example. Internal components 210 may not be visible from outside skull 208.

Since viewpoints of interest (e.g., viewpoints 212a and 212b) in the example implementation illustrated in FIG. 2A lie outside skull 208, and at least some of the exterior surface of skull 208 is opaque, it can be determined by tracing rays (e.g., rays 214a and 214b in cones 216a and 216b, respectively) that at least some polygons belonging to internal components 210 are not visible from at least some of the viewpoints. Polygon mesh model 200a can be selectively decimated by removing triangles that are non-visible from all of the viewpoints of interest. Triangles that are non-visible from a particular viewpoint are triangles that cannot be seen from that viewpoint.

In this example, at least some polygons of internal components 210 are removed from polygon mesh model 200a. FIG. 2B is a schematic drawing of a side view of polygon mesh model 200b generated by selectively decimating polygon mesh model 200a of FIG. 2A, in accordance with the present systems, devices, and methods.

The robot's head may be articulated, for example at neck 202. Visibility of polygons in the polygon mesh model can be determined for one or more articulations, e.g., a position of neck 202 with respect to the rest of the robot's head.

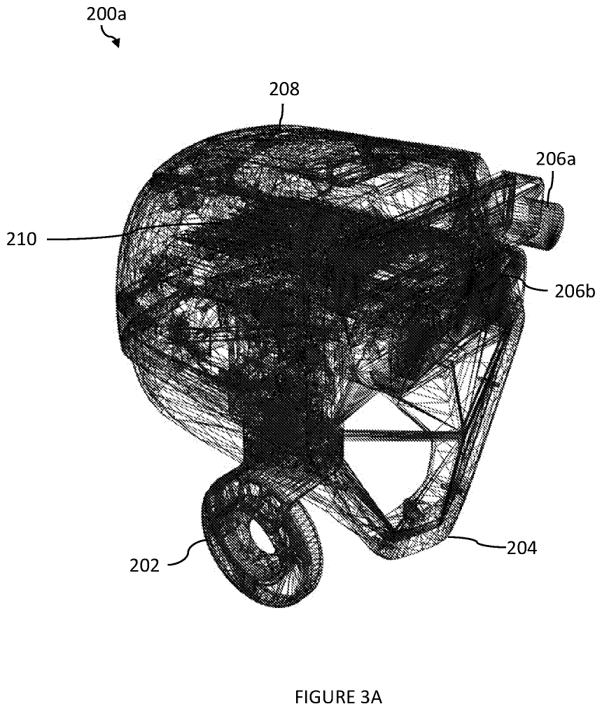

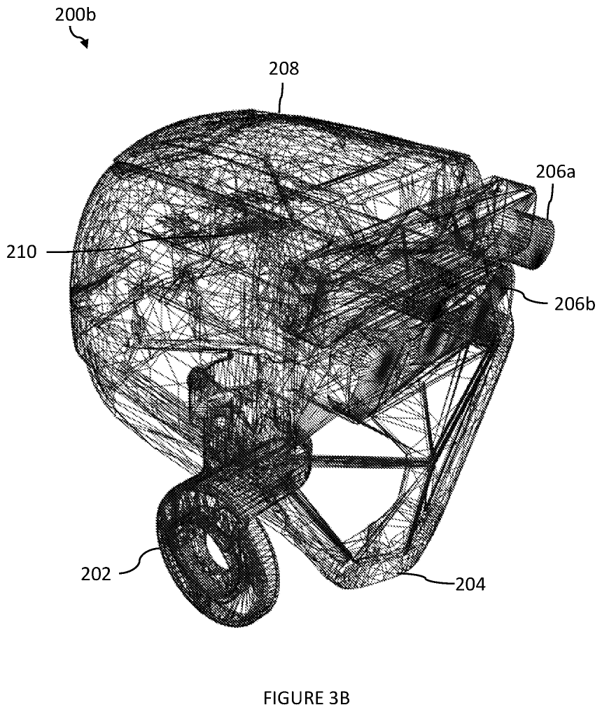

FIG. 3A is a schematic drawing of an isometric view of polygon mesh model 200a of FIG. 2A before selective decimation, in accordance with the present systems, devices, and methods.

FIG. 3B is a schematic drawing of an isometric view of polygon mesh model 200b of FIG. 2B generated by selectively decimating polygon mesh model 200a of FIG. 2A, in accordance with the present systems, devices, and methods.

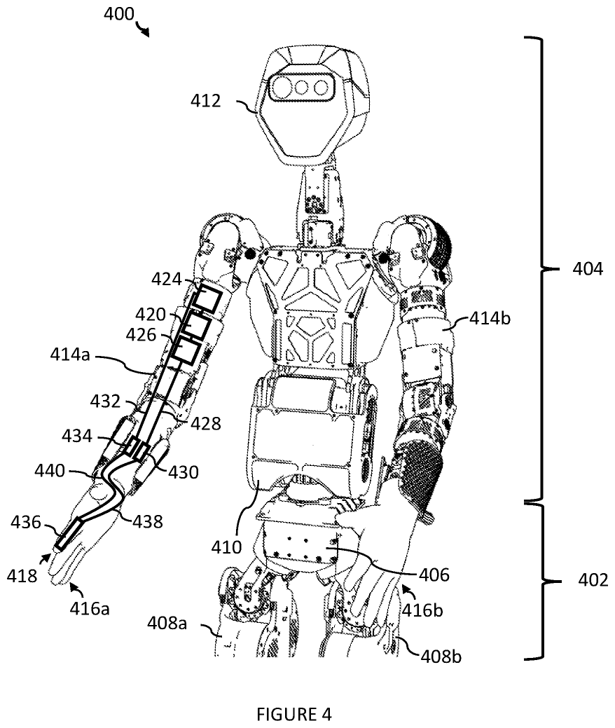

Polygon mesh models 200a and 200b of FIGS. 2A and 2B, respectively, may be polygon mesh models of a CAD model of a hydraulically-powered robot, for example. FIG. 4 is a schematic drawing of an example implementation of a hydraulically-powered robot 400, in accordance with the present systems, devices, and methods.

Robot 400 comprises a base 402 and a humanoid upper body 404. Base 402 comprises a pelvic region 406 and two legs 408a and 408b (collectively referred to as legs 408). Only the upper portion of legs 408 is shown in FIG. 4. In other example implementations, base 402 may comprise a stand and (optionally) one or more wheels.

Upper body 404 comprises a torso 410, a head 412, right-side arm 414a and a left-side arm 414b (collectively referred to as arms 414), and a right hand 416a and a left hand 416b (collectively referred to as hands 416). Arms 414 of robot 400 are also referred to in the present application as robotic arms. Arms 414 of robot 400 are humanoid arms. In other implementations, arms 414 have a form factor that is different from a form factor of a humanoid arm.

Hands 416 are also referred to in the present application as end effectors. In other implementations, hands 416 have a form factor that is different from a form factor of a humanoid hand. Each of hands 416 comprises one or more digits, for example, digit 418 of hand 416a. Digits may include fingers, thumbs, or similar structures of the hand or end effector.

Robot 400 is a hydraulically-powered robot. In other implementations, robot 400 has alternative or additional power systems. In some implementations, base 402 and/or torso 410 of upper body 404 house a hydraulic control system, for example. In some implementations, components of the hydraulic control system may alternatively be located outside the robot, e.g., on a wheeled unit that rolls with the robot as it moves around, or in a fixed station to which the robot is tethered.

The hydraulic control system of robot 400 comprises a hydraulic pump 422, a reservoir 424, and an accumulator 426, housed in arm 414a. Hose 428 provides a hydraulic coupling between accumulator 426 and a pressure valve 430 of the hydraulic control system. Hose 432 provides a hydraulic coupling between an exhaust valve 434 of the hydraulic control system and reservoir 424.

Pressure valve 430 is hydraulically coupled to an actuation piston 436 by a hose 438. Actuation piston 436 is hydraulically coupled to exhaust valve 434 by a hose 440. Hoses 428 and 438, and pressure valve 430, provide a forward path to actuation piston 436. Hoses 432 and 440, and exhaust valve 434 provide a return path to actuation piston 436. Pressure valve 430 and exhaust valve 434 can control actuation piston 436, and can cause actuation piston 436 to move, which can cause a corresponding motion of at least a portion of hand 416a, for example, digit 418.

Each of hands 416 may have more than one degree of freedom (DOF). In some implementations, each hand has up to eighteen (18) DOFs. Each DOF can be driven by a respective actuation piston (for example, actuation piston 436). For clarity of illustration, only one actuation piston is shown in FIG. 4. Each actuation piston may be located in hands 416.

In some implementations, digit 418 may include multiple actuators. Some actuators may be used to control movement of joints in digit 418. For example, actuators may be used to control movement of one or more knuckle joints.

Digit 418 may include one or more knuckle joints. For example, digit 418 may include one or more of a metacarpophalangeal (MCP) joint, a proximal interphalangeal (PIP) joint, and a distal interphalangeal (DIP) joint. Digit 418 may include a spherical differential joint (e.g., a spherical differential MCP joint) as described above (for example, the joint of portion 100c of FIG. 10). The spherical differential joint of digit 418 may be hydraulically-actuated.

Digit 418 may include one or more position transducers operable to provide positional data for robot 400 to be self-aware of a position of one or more components of digit 418 with respect to each other, and/or to provide control of digit 418.

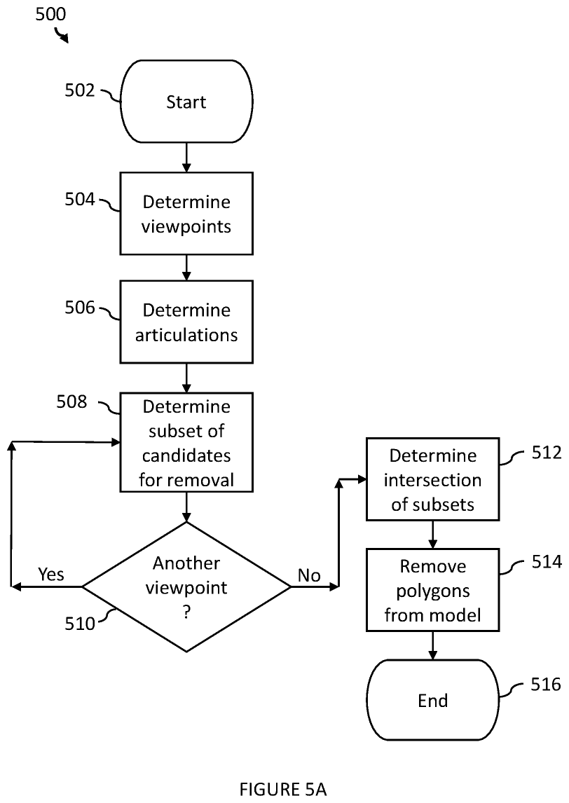

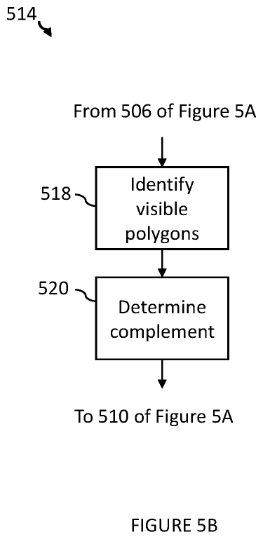

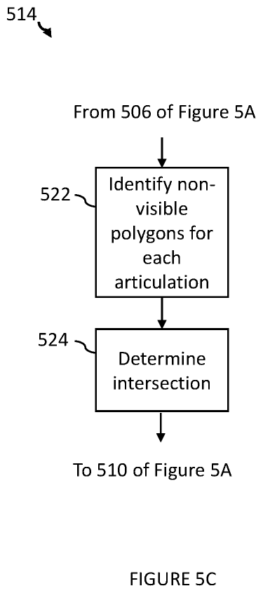

FIG. 5A is a flow chart of an example implementation of a computer-implemented method 500 for reducing a number of polygons in a polygon mesh model of an object, in accordance with the present systems, devices, and methods. Method 500 of FIG. 5A includes eight (8) acts 502, 504, 506, 508, 510, 512, 514, and 516. Those of skill in the art will appreciate that in alternative implementations certain acts of FIG. 5A may be omitted and/or additional acts may be added. Those of skill in the art will also appreciate that the illustrated order of the acts is shown for exemplary purposes only and may change in alternative implementations.

At 502, in response to a starting condition (e.g., receipt of a polygon mesh model), method 500 starts. At 504, the computer determines a number of viewpoints of interest. In some implementations, the viewpoints are a representative sample of viewpoints. In some implementations, the viewpoints are a random sample. In some implementations, the viewpoints are located on one or more bounding spheres of an object.

At 506, in some implementations, the computer determines a number of articulations of interest. In other implementations, 506 is skipped.

At 508, the computer determines a subset of candidates for removal. At 510, the computer determines whether there is another viewpoint. If there is another viewpoint, then control of method 500 returns to 508, otherwise method 500 proceeds to 512.

At 512, the computer determines an intersection of the subsets of candidates for removal. At 514, the computer removes polygons from the polygon mesh model.

At 516, method 500 ends.

FIG. 5B is a flow chart of an example implementation of act 508 of method 500 of FIG. 5A, in accordance with the present systems, devices, and methods. Act 508 of FIG. 5B includes two (2) acts 518 and 520. Those of skill in the art will appreciate that in alternative implementations certain acts of FIG. 5B may be omitted and/or additional acts may be added. Those of skill in the art will also appreciate that the illustrated order of the acts is shown for exemplary purposes only and may change in alternative implementations.

At 518, the computer identifies visible polygons. At 520, the computer determines a complement of the set of visible polygons (i.e., polygons not in the set of visible polygons), after which control of method 500 returns to 510 of FIG. 5A.

FIG. 5C is a flow chart of another example implementation of act 508 of method 500 of FIG. 5A in accordance with the present systems, devices, and methods. Act 508 of FIG. 5C includes two (2) acts 522 and 524. Those of skill in the art will appreciate that in alternative implementations certain acts of FIG. 5C may be omitted and/or additional acts may be added. Those of skill in the art will also appreciate that the illustrated order of the acts is shown for exemplary purposes only and may change in alternative implementations.

At 522, the computer identifies non-visible polygons for each articulation. At 524, the computer determines an intersection of the sets, after which control of method 500 returns to 510 of FIG. 5A.

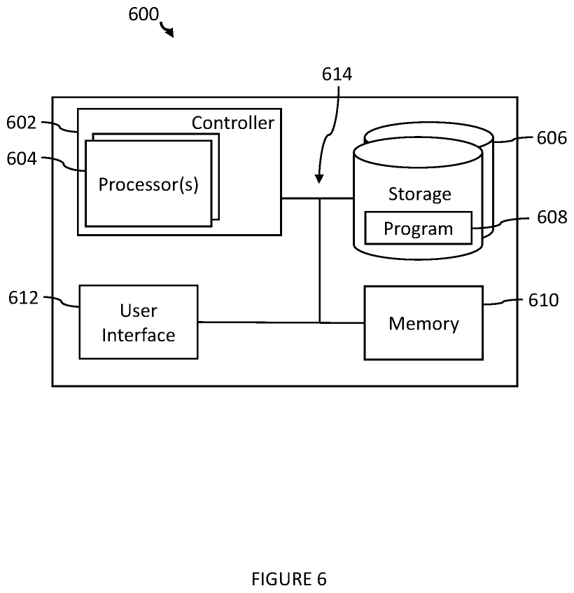

FIG. 6 is a block diagram of an example implementation of a computer 600, in accordance with the present systems, devices, and methods. Computer 600 comprises a controller 602. Controller 602 comprises at least one processor 604. Processor 604 may be any logic processing unit, including for example, one or more central processing units (“CPUs”), digital signal processors (“DSPs”), and/or application-specific integrated circuits (“ASICs”).

Computer 600 further comprises at least one non-transitory processor-readable storage medium 606 communicatively coupled to processor 604. Storage medium 606 can store instructions and/or data that can be executed by processor 604. Storage medium 606 can store a computer program product 608 comprising data and processor-executable instructions. The computer program product can cause processor 604 to perform a method for reducing a number of polygons in a polygon mesh model of an object. For example, the computer program product can cause processor 604 to perform method 500 of FIG. 5. Storage medium 606 may be any suitable non-volatile storage medium, including for example, a hard disk drive for reading from and writing to a hard disk, a solid state drive, an optical disk drive for reading from and writing to removable optical disks, and/or a magnetic disk drive for reading from and writing to magnetic disks.

Computer 600 further comprises memory 610 and user interface 612. Computer program product 608 can be loaded into memory 610. Controller 602, storage medium 606, memory 610, and user interface 612 are communicatively coupled to one another by a bus 614. Bus 614 can employ any known bus structures or architectures, including for example, a memory bus with a memory controller, a peripheral bus, and/or a local bus. Memory 610 may include non-transitory memory and/or non-volatile memory, including for example, read-only memory (ROM) and/or volatile memory such as random access memory (RAM). A basic input/output system (BIOS) may form part of the ROM, and may contain basic routines that help transfer information between elements within computer 600, for example during startup.

The various implementations described herein may include, or be combined with, any or all of the systems, devices, and methods described in U.S. patent application Ser. No. 17/566,589, U.S. patent application Ser. No. 17/846,243, and/or U.S. Provisional Patent Application Ser. No. 63/351,274, all of which are incorporated herein by reference in their entirety.

Throughout this specification and the appended claims, infinitive verb forms are often used. Examples include, without limitation: “to provide,” “to control,” and the like. Unless the specific context requires otherwise, such infinitive verb forms are used in an open, inclusive sense, that is as “to, at least, provide,” “to, at least, control,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of robotic systems and hydraulic circuits provided.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A computer-implemented method for reducing a number of polygons in a polygon mesh model of an object, the polygon mesh model of the object comprising a set of one or more polygons, wherein the reducing a number of polygons in a polygon mesh model of an object includes:
determining one or more viewpoints;
for each viewpoint of the one or more viewpoints, determining a respective first subset of polygons of the set of one or more polygons, the respective first subset of polygons being candidates for removal from the polygon mesh model;
determining a first intersection of the respective first subsets of polygons; and
removing from the polygon mesh model at least some of the polygons in the first intersection.

2. The method of claim 1, wherein the object comprises a plurality of parts, and the reducing a number of polygons in a polygon mesh model of an object includes removing at least a portion of a first part.

3. The method of claim 2, wherein the polygon mesh model includes a first polygon mesh of the first part, the at least of a portion of the first part consists of a second subset of the set of one or more polygons, and the removing at least a portion of the first part includes removing the second subset from the polygon mesh model.

4. The method of claim 1, wherein the object comprises a plurality of parts, the polygon mesh model comprises a first polygon mesh for a first part of the plurality of parts, and the reducing a number of polygons in a polygon mesh model of an object includes decimating the first polygon mesh.

5. The method of claim 1, wherein the object is a CAD model.

6. The method of claim 5, wherein the CAD model includes an internal surface, the internal surface non-visible for each viewpoint of the one or more viewpoints, wherein the removing from the polygon mesh model at least some of the polygons in the first intersection includes removing at least some of the polygons of the internal surface.

7. The method of claim 1, wherein the object is a simulated representation of a physical object.

8. The method of claim 1, wherein the object includes a robot.

9. The method of claim 1, wherein the object includes an environment of a robot.

10. The method of claim 1, wherein the set of one or more polygons is a set of one or more triangles.

11. The method of claim 1, wherein the determining one or more viewpoints includes determining one or more randomly-located points on one or more bounding spheres of the object.

12. The method of claim 1, wherein, for each viewpoint of the one or more viewpoints, the determining a respective first subset of polygons of the set of one or more polygons, the respective first subset of polygons being candidates for removal from the polygon mesh model, includes identifying polygons of the set of one or more polygons which are non-visible from the viewpoint.

13. The method of claim 12, wherein the identifying polygons of the set of one or more polygons which are non-visible from the viewpoint includes determining which polygons of the set of one or more polygons are untouched by rays drawn to the object from the viewpoint.

14. The method of claim 13, wherein the determining which polygons of the set of one or more polygons are untouched by rays drawn to the object from the viewpoint includes determining which polygons of the set of one or more polygons are untouched by straight-line rays drawn to the object from the viewpoint.

15. The method of claim 1, wherein, in operation, the polygon mesh model of the object is used in a computer simulation, and the determining a respective first subset of polygons of the set of one or more polygons, the respective first subset of polygons being candidates for removal from the polygon mesh model, includes identifying polygons of the set of one or more polygons which are non-visible in the computer simulation from the viewpoint.

16. The method of claim 1, wherein, for each viewpoint of the one or more viewpoints, the determining a respective first subset of polygons of the set of one or more polygons, the respective first subset of polygons being candidates for removal from the polygon mesh model, includes:
identifying a respective second subset of polygons of the set of one or more polygons, the respective second subset of polygons which are visible from the viewpoint; and
determining the respective first subset of polygons of the set of one or more polygons from at least some of the polygons in a complement of the respective second subset of polygons.

17. The method of claim 1, further comprising determining one or more articulations of the object, wherein, for each viewpoint of the one or more viewpoints, the determining a respective first subset of polygons of the set of one or more polygons, the respective first subset of polygons being candidates for removal from the polygon mesh model, includes:
for each articulation, determining a respective second subset of polygons of the set of one or more polygons, the respective second subset of polygons which are non-visible from the viewpoint;
determining a second intersection of the respective second subsets of polygons; and
determining the respective first subset of polygons from at least some of the polygons in the second intersection.
